(19) United States
(12) Patent Application Publication
(10) Pub. No.: US 2025/0355659 A1
(43) Pub. Date: Nov. 20, 2025

(54) USER INTERFACE TESTING USING LARGE LANGUAGE MODELS

(71) Applicant: MICROSOFT TECHNOLOGY LICENSING, LLC., REDMOND, WA (US)

(72) Inventors: HUANING CAI, REDMOND, WA (US); RALF LEIBOLD, JULICH (DE); SHUNFU MAO, SEATTLE, WA (US); GREGORY WARD RATAJIK, SEATTLE, WA (US); ZHI WANG, ISSAQUAH, WA (US)

(21) Appl. No.: 18/664,287

(22) Filed: May 15, 2024

(51) Int. Cl. G06F 8/65; G06F 8/10; G06F 8/38; G06F 11/36

(52) U.S. Cl. CPC G06F 8/65; G06F 8/10; G06F 8/38; G06F 11/3668

(57) ABSTRACT

A user interface testing system employs an AI-assisted description generator and an AI-assisted test engine to test various visual features of a user interface with respect to the design specification of the user interface. In an aspect, the AI-assisted test engine is given a natural language description of the implementation snapshot of the user interface and a natural language description of the visual feature being tested and determines whether or not the implemented user interface contains design defects. The AI-assisted description generator produces the natural language description of the implementation of the user interface from a snapshot of the implementation and produces the natural language description of the visual feature from a snapshot of the visual feature.

### BACKGROUND

A user interface (UI) provides a user with a means to interact with a software application or website. The user interface typically contains graphical components such as menus, buttons, icons, tabs, scroll bars, pointers, windows, and other user controls. This graphical user interface (GUI) eliminates the need for a user to learn a text-based command interface that requires the user to type in long lines of code at a command line interface. The GUI is easier to use since the user can select a button or icon to execute a feature of the application. The goal of a user interface is to make the interaction with the application easy and efficient so that the user enjoys interacting with the application.

Testing of the user interface ensures that the user interface operates as designed. A functional test focuses on whether the features of the user interface that interact with the user perform as intended. For example, a functional test of a user interface checks the workflow of a login page where a user provides a username and a password, clicks a sign-in button and obtains a message indicating a successful login. However, a functional test cannot detect whether the user interface aligns with a design specification especially with regard to visual defects that often require a manual visual inspection.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A user interface testing system and methodology employs an Artificial Intelligence (AI) assisted description generator and an AI-assisted test engine to test various visual features of a user interface for compliance with a design specification of the user interface. The AI-assisted test engine utilizes a multimodal large language model (LLM) trained on text and visual data and/or a text-based large language model to test an implementation of a user interface against the design specification. In an aspect, the AI-assisted test engine is given a natural language description of an implementation of the user interface and a natural language description of the design specification being tested. The AI-assisted description generator produces the natural language description of the implementation of the user interface from a snapshot of the implementation and the natural language description of the design specification is generated from a snapshot of the visual feature subject to the test.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary system for testing a user interface using a large language model.

FIG. 2 is a flow chart illustrating a first embodiment of an exemplary method of the user interface testing system.

FIG. 3 illustrates a first embodiment of the exemplary user interface testing system that tests a user interface of an application given an implementation snapshot and a design specification snapshot.

FIG. 4 is a flow chart illustrating a second embodiment of an exemplary method of the user interface testing system.

FIG. 5 illustrates a second embodiment of the exemplary user interface testing system that tests a user interface of an application given an implementation snapshot and a design specification description.

FIG. 6 is a flow chart illustrating a third embodiment of an exemplary method of the user interface testing system.

FIG. 7 illustrates a third embodiment of the exemplary user interface testing system that tests a user interface of an application given an implementation snapshot and a design specification description.

FIG. 8 is a block diagram illustrating an exemplary operating environment.

FIG. 9 illustrates an embodiment of an exemplary technique to repair the user interface when the user interface contains a design defect.

### DETAILED DESCRIPTION

### Overview

An application includes a graphical user interface having a visual display that is to adhere to a design specification. In an aspect, the design specification details the visual features of the user interface, such as, without limitation, the page layout, text font size, color/contrast, font weight, font decoration, font capitalization, background color, border, shadows, border-radius, spacing in and around text, bounding region size, animation or motion effects, layout position, visual grouping, length of statements, wordiness of statement, left-to-right alignment of text, tone of images, natural language, and text and shapes used in the user interface.

The testing of the visual features of the user interface with respect to the design specification is performed by utilizing an AI-assisted description generator and an AI-assisted test engine. The AI-assisted test engine utilizes a multimodal machine learning model trained on text and visual data or a text-based machine learning model to analyze an implementation of the user interface against the design specification. In an aspect, the AI-assisted description generator produces the natural language description of the user interface implementation from a snapshot of the user interface implementation and produces the natural language description of the design specification from a snapshot of the visual feature being tested.

The term “snapshot” is defined below. The design specification includes images so it is possible to take a snapshot of the visual feature being tested from the design specification. The AI-assisted description generator uses a machine learning model to generate the natural language descriptions. In some instances, the natural language descriptions generate better responses from the machine learning model since the model is trained with more natural language training samples from various domains.

Attention now turns to a more detailed description of the system, device, and methods for user interface testing.

### System

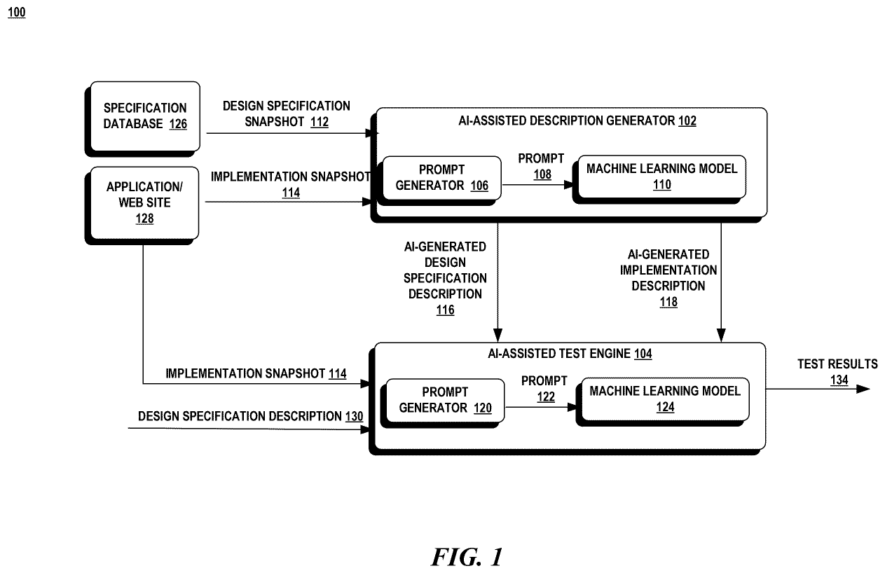

FIG. 1 illustrates an exemplary system 100 for testing a user interface. In an aspect, the system comprises an AI-assisted description generator 102 and an AI-assisted test engine 104. The AI-assisted description generator 102 includes a prompt generator 106 and a machine learning model trained to understand and analyze visual and natural language data 110. The AI-assisted description generator 102 produces an AI-generated design specification description 116 and/or AI-generated implementation description 118.

The AI-assisted description generator 102 receives an implementation snapshot 114 and/or a design specification snapshot 112. The implementation snapshot 114 is a visual image of an implementation of a user interface from an application or website 128 that utilizes the user interface. The design specification snapshot 112 is a visual image of the design specification of the feature being tested. The implementation snapshot 114 and the design specification snapshot 112 may be configured as a digital image in an image file format such as, without limitation, a Joint Photographic Experts Group (JPEG) file, a Portable Network Graphics (PNG) file, Graphics Interchange File (GIF) file, or Portable Document Format (PDF) file.

The design specification snapshot is typically generated by a user experience (UX) designer based on product features produced by product managers. The UX designer can use software tools such as Figma to produce the snapshots. The implementation snapshot can be captured programmatically in a test environment. For example, an execution engine can open the application in the test environment, and the test environment calls an Application Programming Interface (API) which captures how the application UI is at a particular application state.

The AI-assisted test engine 104 analyzes either the implementation snapshot of the user interface 114 or the AI-generated implementation description of the user interface 118 with a design specification description of the visual feature being tested 130, or an AI-generated design specification description 116.

The AI-assisted test engine 104 includes a prompt generator 120 and a machine learning model 124. The prompt generator 120 generates a prompt 122 which instructs the machine learning model 124 to determine whether or not the implementation of the user interface complies with the design specification for a particular visual feature. The prompt 122 includes the AI-generated implementation description 118 and the design specification description 130 or the AI-generated specification description 116.

The AI-assisted test engine 104 produces test results 134 that contain a response to the prompt indicating whether or not the implementation of the user interface complies with the design specification. In the case, where the implementation of the user interface fails to comply with the design specification, the AI-assisted test engine generates a repair which is then implemented.

In an aspect, the machine learning model 124 used by the AI-assisted test engine is a large language model. The machine learning model 110 used by the AI-assisted description generator may also be a large language model. In some cases, there is a single machine learning model used by both the AI-assisted description generator 102 and the AI-assisted test engine 104.

A large language model is a type of machine learning model trained on a massively-large training dataset of text data, visual data and/or source code and contains billions of parameters. The large language model is used to perform various tasks such as natural language processing, text generation, machine translation, and source code generation. The large language model is formed from deep learning neural networks such as a neural transformer model with attention. Examples of the large language models include the conversational pre-trained generative neural transformer models with attention offered by OpenAI™ (i.e., ChatGPT™, Codex models, (Generative Pre-trained Transformer—4 Vision) GPT-V™, GPT models), PaLM and Chinchilla by Google®, LLaMa by Meta, and LLaVA from Microsoft®.

The neural transformer model with attention is one distinct type of machine learning model. Machine learning pertains to the use and development of computer systems that are able to learn and adapt without following explicit instructions by using algorithms and statistical models to analyze and draw inferences from patterns in data. Machine learning uses different types of statistical methods to learn from data and to generate future decisions. Traditional machine learning includes classification models, data mining, Bayesian networks, Markov models, clustering, and visual data mapping.

Deep machine learning differs from traditional machine learning since it uses multiple stages of data processing through many hidden layers of a neural network to learn and interpret the features and the relationships between the features. Deep machine learning embodies neural networks which differs from the traditional machine learning techniques that do not use neural networks. There are various types of deep machine learning models, such as recurrent neural network (RNN) models, convolutional neural network (CNN) models, long short-term memory (LSTM) models, and neural transformers with attention.

In an aspect, the application or website using the user interface 128 is located on one computing device, the AI-assisted description generator and the AI-assisted test engine are located on the same or another computing device and the large language models are located on one or more servers, separate from the other computing devices.

A large language model is typically given a user prompt that consists of text and image content in the form of a question, an instruction, short paragraph and/or source code. The prompt instructs the model to perform a task given data and/or indicates the format of the intended response. The image content can be an image URL, or base64 encoding of an image. In an aspect, the server and the user computing device communicate through HTTP-based Representational State Transfer (REST) Application Programming Interfaces (API). A REST API or web API is an API that conforms to the REST protocol. In the REST protocol, the server contains a publicly-exposed endpoint having a defined request and response structure expressed in a JavaScript Object Notation (JSON) format. An application in the user computing device, such as a web browser or other web application, issues web APIs containing the user prompt to the server to instruct the large language model to perform an intended task.

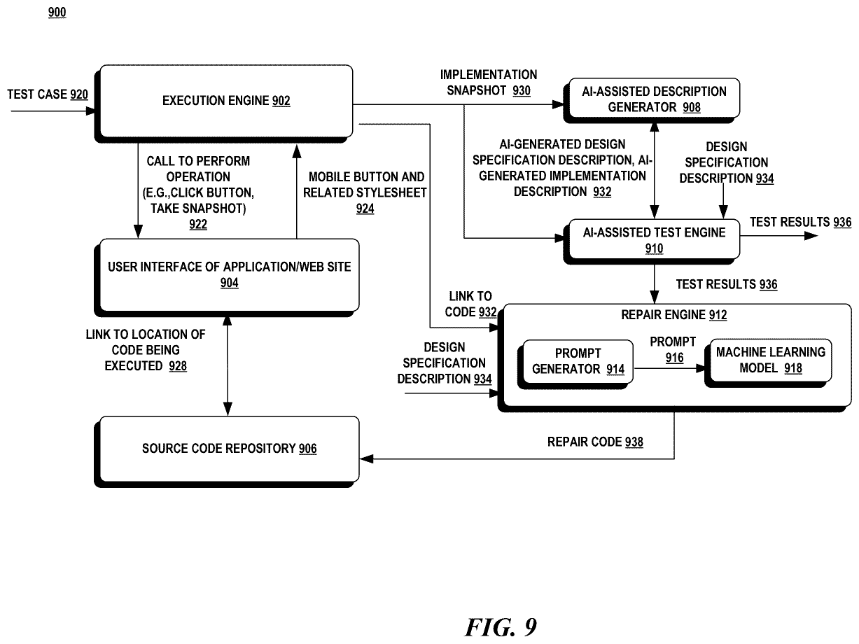

Turning to FIG. 9, there is shown exemplary system 900 for implementing the repair generated from the user interface testing. The repair system 900 includes an execution engine 902 that implements a test case 920 against an implementation of the user interface of a website or application 904. The execution 902 may execute a script file, such as a typescript file, that contains a set of operations to be performed on the user interface 904. For example, an API call may be invoked to click a button on the user interface 922. The user interface performs the operation and returns a response with a link to the code related to the operation 928. For example, the execution engine 902 may receive in response to the API call to click a button, the location of the code that defines the mobile button and related style sheet of the user interface 924. The code may be located in a source code repository, codebase, project, directory, etc. 906.

In addition, the execution engine 902 generates an implementation snapshot of the user interface 930 having executed the test case 920 which is transmitted to an AI-assisted description generator 908 or AI-assisted test engine 910. The AI-assisted test engine 910 receives the design specification description 934 or the AI-generated design specification 932 as well as the implementation snapshot 930 or the AI-generated implementation description 932.

The AI-assisted test engine 910 checks the user interface implementation for compliance with the design specification and outputs the test results 936. The test results 936 indicate whether or not the user interface implementation is in compliance with the design specification. If a visual defect is detected, the test results contain an action needed to repair the visual defect.

When the test results indicate that the user interface implementation is not in compliance with the design specification, then the repair engine 912 is invoked to generate code to repair the design defect. The link to the code used by the application/web site to execute the operation is input to the repair engine 912.

The repair engine 912 includes a prompt generator 914 and a machine learning model 918. The prompt generator creates a prompt 916 to the machine learning model 918 for the machine learning model 918 to generate the repair code 938. The repair code 938 is a corrected version of the original code attributed to the visual design defect. The prompt includes instructions, a link to the code or related code content that needs to be fixed, the test results, and the design specification description 934.

The machine learning model 918 returns a response to the repair engine 912 which includes the repair code which fixed or addressed the design defect 938. The repair code 938 can update the existing version of the code in the source code repository. Alternatively, a pull request is generated to notify the developer or author of the code associated with the visual defect to merge the corrected repair code back into the defected version of the code.

### Methods

Attention now turns to description of the various exemplary methods that utilize the system and device disclosed herein. Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

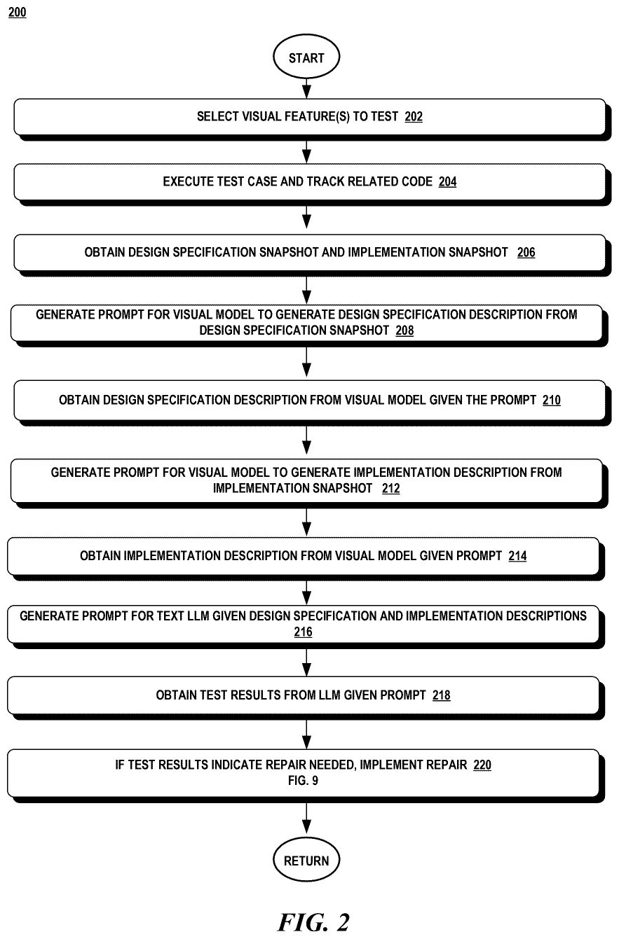

Turning to FIGS. 2 and 9, there is shown a first exemplary method 200 for the UI testing system. The method begins with a selection of a test case which may be received from user input (block 202). The execution engine 902 runs the test case against the user interface of the target application or website (block 204). In an aspect, the test case may be a script containing a set of operations geared to producing a visual effect in the user interface. For each operation that is executed, the execution engine tracks the code used by the user interface to perform the operation (block 204). A link to the location of the code may be saved and later used to repair a detected visual defect (block 204).

The execution engine 902 generates an implementation snapshot of the result of the test case (block 206). A design specification snapshot is generated as well (block 206). The AI-assisted description generator 102 receives the implementation snapshot and the specification snapshot (block 206).

The AI-assisted description generator 102 generates a prompt to a large language model requesting a natural language description of the design specification snapshot (block 208). In an aspect, the large language model is a visual large language model, which is a large language model is trained to recognize and analyze visual data. Examples of such visual large language models include the GPT-vision (GPT-V) model and Large Language and Vision Assistant (LLaVA). The prompt is sent to the large language model (block 208) and the large language model responds with a natural language description of the design specification snapshot (block 210).

The AI-assisted description generator 102 generates another prompt to the large language model requesting a natural language description for the implementation snapshot (block 212). In an aspect, the large language model is trained to recognize and analyze visual data, such as the GPT-vision model. The prompt is sent to the large language model and the large language model responds with a natural language description of the implementation snapshot (block 214).

The AI-assisted test engine 104 receives the AI-generated specification description and the AI-generated implementation description and generates a prompt to a large language model to determine if the implementation complies with the design specification (block 216). The prompt includes instructions for the large language model to analyze both descriptions and to indicate whether the user interface implementation adheres to the design specification description for the visual feature. In an aspect, the large language model is trained to understand and analyze natural language text, such as a ChatGPT model.

The AI-assisted test engine 104 generates test results from the response received from the large language model. The response includes an indication of whether or not the user interface implementation adheres to the design specification for the visual feature (block 218) and provides a repair to alleviate any detected visual defect (block 220).

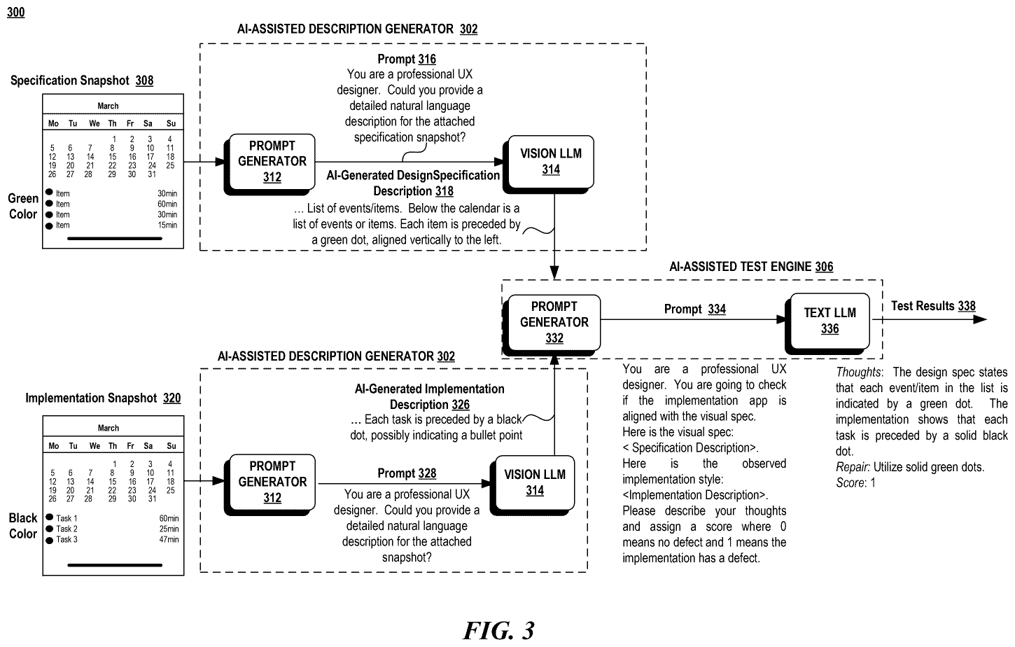

FIG. 3 illustrates the exemplary method shown in FIG. 2 for a user interface on a mobile computing device. The user interface includes a calendar showing the days of the month of March. The specification snapshot 308 is an image that shows a calendar in the user interface with a bullet point listing of items with each bullet in a green color. In the example shown in FIG. 3, the implementation snapshot shows a visual defect with each bullet in a black color.

The prompt generator 312 of the AI-assisted description generator 302 receives a test case 310 which includes the design specification of the visual feature to test. The prompt generator 312 generates a prompt 316 for the vision large language model to generate a natural language description of the visual layout shown in the specification snapshot 308. The vision LLM 314 produces an AI-generated specification description 318 which indicates that a list of events or items is below the calendar where each item is preceded by a green dot.

Prompt generator 312 receives an implementation snapshot 320 of the user interface implemented on a mobile device. The prompt generator 312 creates a prompt 328 which instructs a vision large language model 314 to provide a detailed natural language description for the user interface shown in the implementation snapshot 320. The AI-generated implementation description 326 describes the implementation as having black bullet points—“ . . . Each task is preceded by a black dot, possibly indicating a bullet point”.

Prompt generator 332 of the AI-assisted test engine 306 generates a prompt 334 to a large language model 336 which includes instructions for the large language model 336 to check if the user interface implementation adheres to the visual specification for the user interface. In particular, the model 336 is to generate a score where 0 indicates no defect and a 1 indicates a defect. The prompt 334 includes the AI-generated implementation description 326 and the AI-generated specification description 318. In an aspect, the large language model may be one that is trained to understand and analyze natural language text.

The large language model produces a response or test results 338 that produce a score of 1 and indicates that the implementation does not utilize the specified green bullets. A repair is generated recommending the use of the green bullets. The test results 338 are output to a repair engine that generates repair code to correct the source code attributable to the visual defect as shown in FIG. 9.

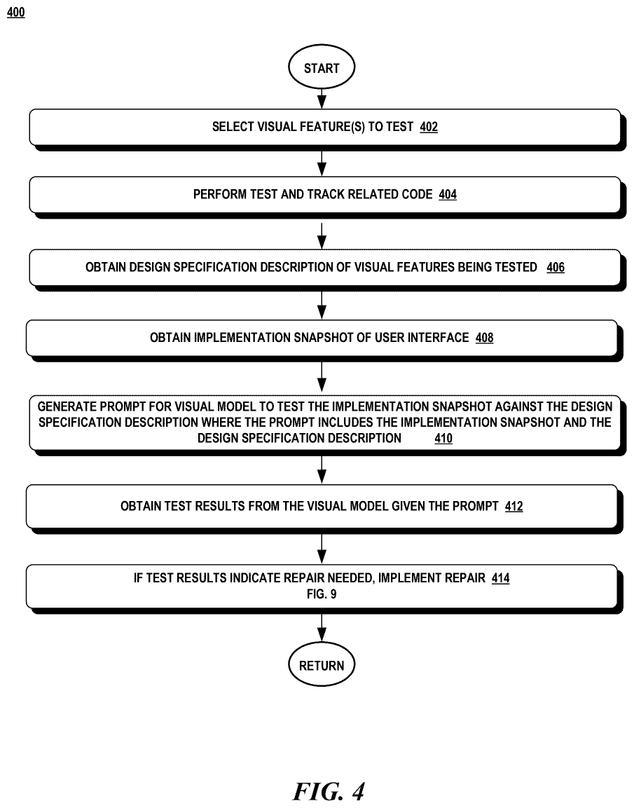

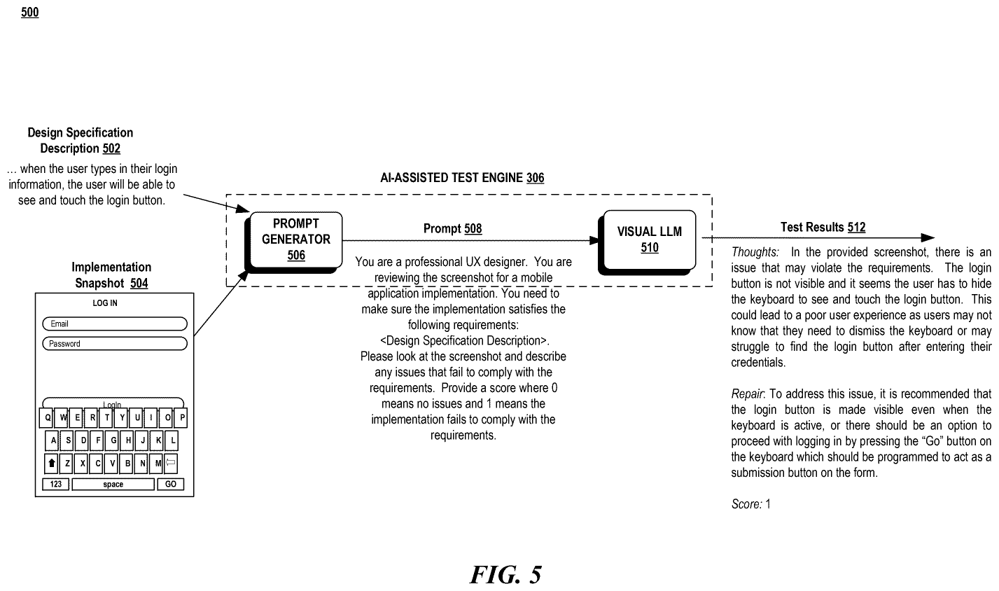

Turning to FIG. 4, there is shown a second exemplary method 400 for the UI testing. FIG. 5 illustrates the second exemplary method 400 used to test the login screen of a mobile computing device. The method 400 begins with a selection of one or more visual features to test (block 402). As shown in FIG. 5, the layout of the login screen is selected for testing.

The execution engine 902 runs a test case that performs a sequence of operations that implements the selected visual features in the user interface (block 404). The execution engine 902 tracks the code that facilitates the visual effects (block 404).

In this method, the AI-assisted test engine receives a specification description of the visual feature being tested (block 406) and an implementation snapshot of the user interface, such as a login screen of the user interface from a mobile computing device (block 408). As shown in FIG. 5, the login screen of the implementation snapshot shows the login button partially hiding under the keyboard of the user interface. The specification description 502 indicates that “when the user types in their login information, the user will be able to see and touch the login button.” Hence, the implementation snapshot has a layout defect.

A prompt 508 is generated by the prompt generator 506 of the AI-assisted test engine (block 410). As shown in FIG. 5, the prompt 508 instructs the vision-trained large language model to look at the implementation snapshot to describe any issues that fail to comply with the specification requirements. In this example, the prompt is sent to a vision-trained large language model 510 having the capability to analyze the implementation snapshot with respect to the specification description.

The visual model outputs test results based on the prompt which is output (block 412). As shown in FIG. 5, the test results 512 indicate the following: “The login button is not visible and it seems the user has to hide the keyboard to see and touch the login button. This could lead to a poor user experience as users may not know that they need to dismiss the keyboard or may struggle to find the login button after entering their credentials.” The test results 512 also include the following repair: “To address this issue, it is recommended that the login button is made visible even when the keyboard is active, or there should be an option to proceed with logging in by pressing the “Go” button on the keyboard which should be programmed to act as a submission button on the form.” The test results 512 also include “Score: 1” indicating a visual defect.

When the test results include a visual defect, the repair engine remedies the visual defect by generating repair code to fix the source code attributable to causing the visual defect (block 414). A prompt is generated to a large language model given the source code attributable to the visual defect tracked by the execution engine, the test results, and the design specification of the test case. The large language model generates a repair to the affected source code (block 414).

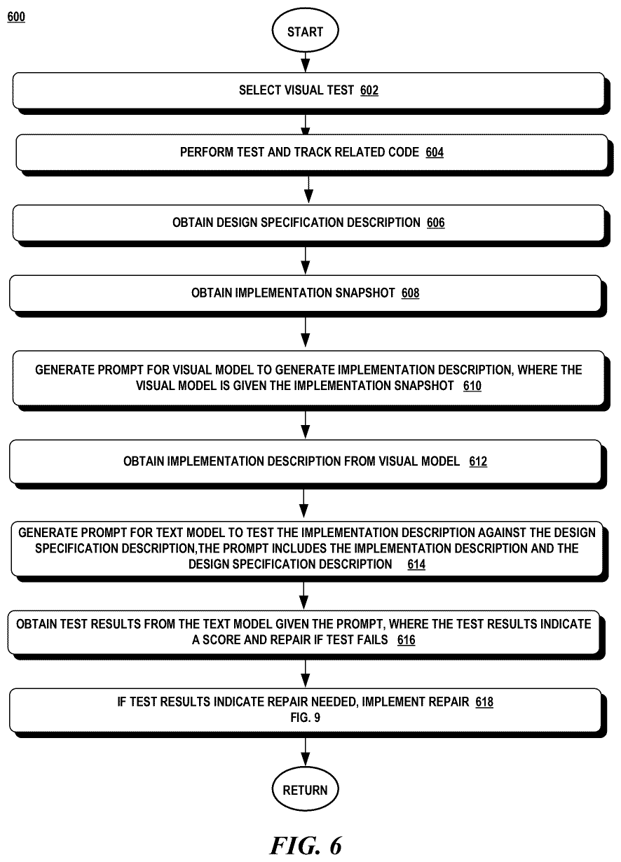

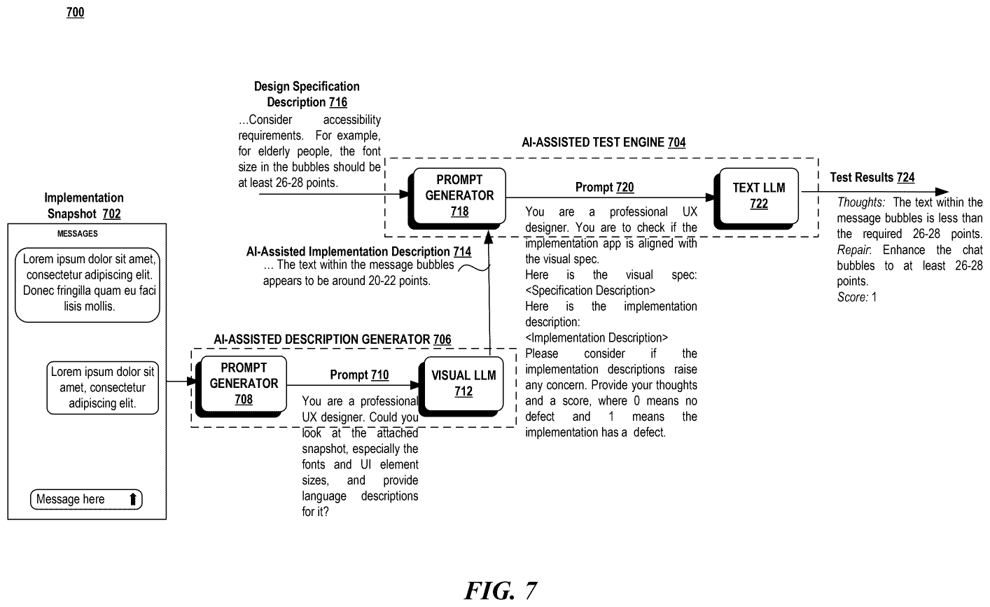

Turning to FIG. 6, there is shown a third exemplary method 600 of the UI testing. FIG. 7 illustrates an exemplary usage of the third exemplary method 700 to test the accessibility requirements of the message user interface of a cellular device. The accessibility requirements pertain to visually impaired and blind users. The accessibility design requirements include visual features for enhanced readability, large interaction components, legible visual contrast, layouts for zoom settings and screen magnification, and large font sizes for text and graphic components.

The method 600 begins with a selection of one or more visual features to test, such as the font sizes and the UI element sizes used in the message chat of the user interface (block 602). The execution engine 902 runs a script that performs operations to generate the selected visual features to test against the user interface of the application or website and tracks the source code producing the tested visual features (block 604).

A specification description is obtained that describes the visual feature being tested (block 606) and an implementation snapshot (block 608). As shown in FIG. 7, the specification description 716 indicates “ . . . Consider accessibility requirements. For example, for elderly people, the font size in the chat bubbles should be at least 26-28 points.” The implementation snapshot of the message user interface 702 shows the chat bubbles having a font size between 20-22 points.

The prompt generator of the AI-assisted description generator generates a prompt (block 608) for a visual LLM to generate a description of the implementation. As shown in FIG. 7, the prompt generator 708 of the AI-assisted description generator 706 receives the implementation snapshot 702 and generates a prompt 710 that includes the implementation snapshot 702 and instructions for a visual LLM 712 to describe the font sizes of the text and the font sizes of the UI elements in the implementation snapshot 702. The visual LLM 712 returns an AI-generated implementation description 714 (block 612).

The prompt generator 718 of the AI-assisted test engine 704 then generates a prompt 720 for a large language model to test the implementation snapshot with the specification description for compliance with the accessibility requirements (block 614). As shown in FIG. 7, the prompt 720 includes the specification description and the implementation description in addition to instructions on the tests the model is to perform.

The large language model 722 generates test results indicating whether the implementation adheres to the accessibility specification (block 616) which are output (block 618). As shown in FIG. 7, the test results 724 indicate that the implementation fails to adhere to the accessibility requirements with a score of 1. The test results indicate that the font size used in the chat bubbles is smaller than the specified 26-28 font size. The repair in the test results indicates to enhance the text in the message bubbles to at least 26-28 points.

When the test results indicate a visual defect, the repair engine generates repair code to remedy the source code attributable to the design defect (block 618). The repair engine generates a prompt to a large language model for the large language model to generate a fix to the source code attributable to the design defect. The prompt includes the test results, the tracked source code related to the design defect, and the design specification associated with the visual features being tested. The large language model returns repair code that contains a fix for the visual defect (block 618).

### Additional Embodiments

The UI testing system and methodology has been described with respect to a few exemplary embodiments shown above but can be applied to other UI defects. For example, localization or translation defects can be readily detected using the technique described above. Localization defects pertain to design specification requirements for a particular geographic or cultural market. The localization requirements include the correct use of a particular natural language, usage of a particular currency, usage of a particular time format, left-to-right alignment of a natural language, or right-to-left alignment of a natural language (e.g., Arabic and Hebrew).

### Exemplary Operating Environment

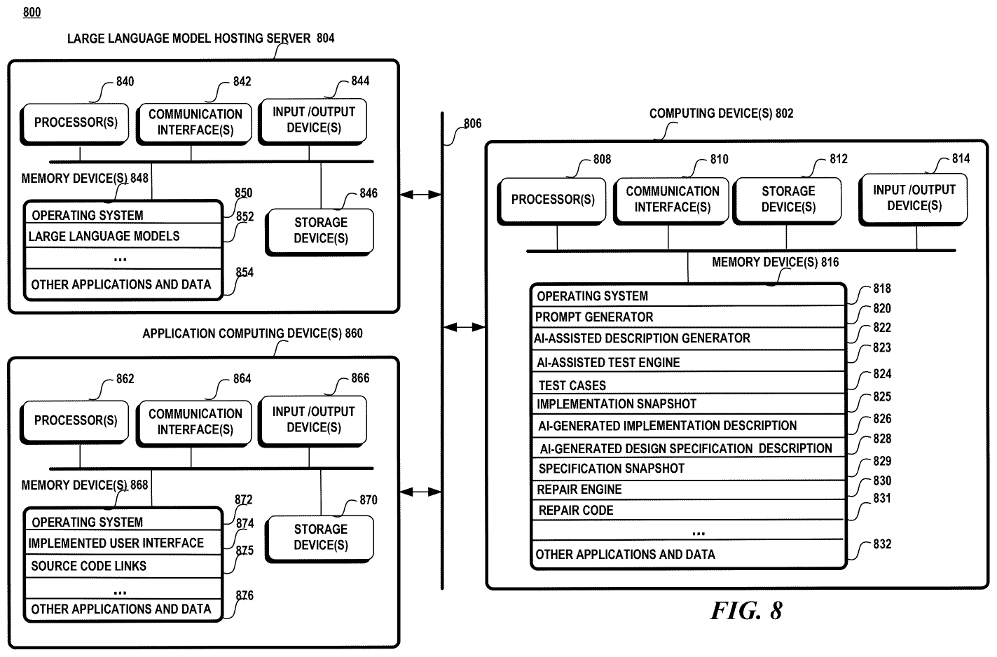

Attention now turns to a discussion of an exemplary operating environment. FIG. 8 illustrates an exemplary operating environment 800. In one embodiment, the operating environment includes a first computing device that hosts the UI testing system, a second computing device that hosts the large language models, a third computing device that hosts the application or website that implemented the user interface and a network that enables communications between the different computing devices. In alternate embodiments, the operating environment may be configured differently with the large language models hosted on the same computing device that hosts the UI testing system and/or the application or website that implemented the user interface being tested. It should be noted that the techniques described herein are not constrained to a particular configuration of the operating environment and that other configurations are possible.

The operating environment 800 includes computing device 802 hosting the UI testing system, computing device 804 hosting the large language models, and computing device 860 hosting the application or website that implemented the user interface. The computing devices 802, 804, 860 may be any type of electronic device or virtual machine, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 800 may be configured in a network environment, a distributed environment, a multi-processor environment, or a stand-alone computing device having access to remote or local storage devices.

A computing device 802, 804, 860 may include one or more processors 808, 840, 862, one or more communication interfaces 810, 842, 864, one or more storage devices 812, 846, 870, one or more input/output devices 814, 844, 866, and one or more memory devices 816, 848, 868. A processor 808, 840, 862 may be any commercially available or customized processor and may include dual microprocessors and multi-processor architectures. A communication interface 810, 842, 864 facilitates wired or wireless communications between the computing device and other devices. A storage device 812, 846, 870 may be a computer-readable medium that does not contain propagating signals, such as modulated data signals transmitted through a carrier wave. Examples of a storage device 812, 846, 870 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 812, 846, 870 in a computing device 802, 804, 860. The input/output devices 814, 844, 866 may include a keyboard, mouse, pen, voice input device, touch input device, display, speakers, printers, etc., and any combination thereof.

A memory device or memory 816, 848, 868 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 816, 848, 868 may also include one or more external storage devices or remotely located storage devices that do not pertain to propagated signals, such as modulated data signals transmitted through a carrier wave.

A memory device 816, 848, 868 contains instructions, components, and data. A component is a software program that performs a specific function and is otherwise known as a module, program, component, and/or application. Memory device 816 includes an operating system 818, a prompt generator 820, an AI-assisted description generator 822, an AI-assisted test engine 823, test cases 824, an implementation snapshot 825, an AI-generated implementation description 826, an AI-generated specification description 828, a specification snapshot 829, repair engine 830, repair code 831, and other applications and data 832. Memory device 848 includes an operating system 850, several large language models 852, and other applications and data 854. Memory device 868 includes an operating system 872, an implemented user interface 874, source code links 875, and other applications and data 876.

The network 806 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 806 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Technical Effect

Aspects of the subject matter disclosed is an improvement to the functioning of a computer. In an aspect, the techniques described herein test an implemented user interface for visual defects that fail to comply with a design specification. The technical feature associated with addressing this problem is the conversion of the snapshots of the implemented user interface and/or the specification snapshot into natural language text and the use of a neural network-based model to perform the test based on the machine-generated natural language descriptions. The technical effect achieved is the detection of visual defects in a user interface, automatically without a manual visual inspection, which are remedied prior to internal or production releases of the user interface thereby improving the functioning of the computer through a well-tested user interface.

### CONCLUSION

The techniques described herein pertain to the testing of a user interface in a manner that improves the functioning of a computer over conventional solutions. Conventional solutions rely on manual visual inspection to detect visual defects in a proposed user interface. The techniques described herein utilize a machine learning model to convert a visual image of the user interface and the design specification into natural language text for the UI test to be performed automatically, without manual intervention. This enables the testing process to automatically detect visual defects quickly and more efficiently.

One of ordinary skill in the art understands that the techniques disclosed herein are inherently digital. The human mind cannot interface directly with a CPU or network interface card, or other processor, or with RAM or other digital storage, to read or write the necessary data and perform the necessary operations disclosed herein.

The embodiments are also presumed to be capable of operating at scale, within tight timing constraints in production environments (e.g., integrated development environment), and in testing labs for production environments as opposed to being mere thought experiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A system is disclosed for testing a user interface for compliance with a design specification. The system comprises a processor and a memory that stores a program configured to be executed by the processor. The program comprises instructions that when executed by the processor performs acts that: select a visual feature from a design specification of the user interface to test, wherein the visual feature pertains to a graphic component of the user interface specified to appear in the user interface in accordance with the design specification; obtain a natural language description of the design specification of the visual feature; obtain a visual image of an implementation of the user interface; generate natural language description of the visual image of the implementation of the user interface; generate a prompt to a large language model, wherein the prompt comprises an instruction for the large language model to determine whether the visual image of the implementation of the user interface adheres to the design specification of the visual feature, wherein the large language model is given the natural language description of the visual image of the implementation of the user interface and the natural language description of the design specification of the visual feature; obtain from the large language model, given the prompt, a response, wherein the response determines whether or not the implementation of the user interface adheres to the specification of the visual feature; obtain from the response a suggested repair when non-compliance to the design specification of the visual feature is generated; and upon the large language model indicating that the implementation of the user interface fails to adhere to the design specification of the visual feature, generate a repair.

In an aspect, the program comprises further instructions that when executed by the processor performs acts that: generate natural language text describing the visual image of the visual feature of the implementation of the user interface from a visual large language model.

In an aspect, the program comprises instructions that when executed by the processor performs acts that: generate a prompt for the visual large language model to generate the natural language text, wherein the prompt comprises the visual image of the implementation of the user interface.

In an aspect, the visual large language model is a neural transformer model with attention trained on visual and text data. In an aspect, the visual feature pertains to an accessibility requirement, wherein the accessibility requirement specifies a font size or a graphic component size. In an aspect, the visual feature pertains to a localization requirement, wherein the localization requirement specifies a natural language, local currency usage, local time format, left-to-right reading convention, or right-to-left convention, or wherein the visual feature pertains to placement of graphic components in a graphic layout of the user interface. In an aspect, the program performs acts that update the implementation of the user interface according to the repair.

A computer-implemented method is disclosed for testing a user interface comprising: providing a test case from a design specification of the user interface to test, wherein the test case pertains to localization requirements of the user interface for a particular geographic region; obtaining a natural language description of the test case; representing, in a natural language description, a visual image of an implementation of the user interface; generating a first prompt to a first large language model, wherein the first prompt comprises an instruction for the first large language model to determine whether the visual image of the implementation of the user interface adheres to the natural language description of the test case, wherein the first large language model is given the natural language description of the visual image of the implementation of the user interface and the natural language description of the test case; determining from a response obtained from the first large language model, given the first prompt, whether or not the implementation of the user interface adheres to the localization requirements of the user interface; obtaining from the response a suggested repair when non-compliance of the localization requirements is generated; and upon the first large language model indicating that the implementation of the user interface fails to adhere to the localization requirements, outputting the suggested repair.

In an aspect, the first large language model is trained on natural language data. In an aspect, the first large language model is trained on natural language data and visual data. In an aspect, the method further comprises: generating a second prompt to a second large language model comprising a snapshot of the test case; and receiving the natural language description of the test case from the second large language model in response to the prompt.

In an aspect, the second large language model is trained on natural language and visual data. In an aspect, the method further comprises: creating a snapshot of the implementation of the user interface; generating a third prompt to a visual large language model, wherein the third prompt comprises the snapshot of the implementation of the user interface; and receiving the natural language description of the snapshot of the implementation of the user interface.

In an aspect, the localization requirements specify a natural language, a left-to-right reading convention, local currency, local time format, or a right-to-left reading convention. In an aspect, the large language model is a neural transformer model with attention.

A hardware storage device is disclosed having stored thereon computer executable instructions that are structured to be executed by a processor of a computing device to thereby cause the computing device to perform actions that: employ a first large language model to generate a natural language description of a specification of a design feature of a user interface from a snapshot of the specification of the design feature; employ the first large language model to generate a natural language description of an implementation of the user interface from a snapshot of the implementation of the user interface; employ a second large language model to determine whether the implementation of the user interface adheres to the specification of the design feature, wherein the second large language model is given the natural language description of the implementation of the user interface and the natural language description of the design feature; and upon the second large language model determining that the implementation of the user interface fails to comply with the specification of the design feature, output a repair that remedies the failure.

In an aspect, the first large language model is trained on visual images and natural language data. In an aspect, the second large language model is trained on natural language data. In an aspect, the large language model is a neural transformer model with attention. In an aspect, the design feature pertains to a page layout, text font size, color/contrast, font weight, font decoration, font capitalization, background color, border, shadows, border-radius, spacing in and around text, bounding region size, animation or motion effects, layout position, visual grouping, length of statements, wordiness of statement, left-to-right alignment of text, tone of images, natural language, or text and shapes used in the user interface.

What is claimed:

1. A system for testing a user interface for compliance with a design specification, comprising:
a processor; and
a memory that stores a program configured to be executed by the processor, the program comprising instructions that when executed by the processor performs acts that:
select a visual feature from the design specification of the user interface to test, wherein the visual feature pertains to a graphic component of the user interface specified to appear in the user interface in accordance with the design specification;
obtain a natural language description of the design specification of the visual feature;
obtain a visual image of an implementation of the user interface;
generate natural language description of the visual image of the implementation of the user interface;
generate a prompt to a large language model, wherein the prompt comprises an instruction for the large language model to determine whether the visual image of the implementation of the user interface adheres to the design specification of the visual feature, wherein the large language model is given the natural language description of the visual image of the implementation of the user interface and the natural language description of the design specification of the visual feature;
obtain from the large language model, given the prompt, a response, wherein the response indicates whether or not the implementation of the user interface adheres to the specification of the visual feature;
obtain from the response a suggested repair when non-compliance to the design specification of the visual feature is determined; and
upon the large language model indicating that the implementation of the user interface fails to adhere to the design specification of the visual feature, generate a repair.

2. The system of claim 1, wherein obtain a natural language description of the design specification of the visual feature comprises further instructions that when executed by the processor performs acts that:
generate natural language text describing the visual image of the visual feature of the implementation of the user interface from a visual large language model.

3. The system of claim 2, wherein generate natural language description of the visual image of the implementation of the user interface further comprises instructions that when executed by the processor performs acts that:
generate a prompt for the visual large language model to generate the natural language text, wherein the prompt comprises the visual image of the implementation of the user interface.

4. The system of claim 3, wherein the visual large language model is a neural transformer model with attention trained on visual and text data.

5. The system of claim 1, wherein the visual feature pertains to an accessibility requirement, wherein the accessibility requirement specifies a font size or a graphic component size.

6. The system of claim 1, wherein the visual feature pertains to a localization requirement, wherein the localization requirement specifies a natural language, local currency usage, local time format, left-to-right reading convention, or right-to-left convention, or wherein the visual feature pertains to placement of graphic components in a graphic layout of the user interface.

7. The system of claim 1, wherein the program comprises instructions that when executed by the processor performs acts that update the implementation of the user interface according to the repair.

8. A computer-implemented method for testing a user interface, the method comprising:
providing a test case from a design specification of the user interface to test, wherein the test case pertains to localization requirements of the user interface for a particular geographic region;
obtaining a natural language description of the test case;
representing, in a natural language description, a visual image of an implementation of the user interface;
generating a first prompt to a first large language model, wherein the first prompt comprises an instruction for the first large language model to determine whether the visual image of the implementation of the user interface adheres to the natural language description of the test case, wherein the first large language model is given the natural language description of the visual image of the implementation of the user interface and the natural language description of the test case;
determining from a response obtained from the first large language model, given the first prompt, whether or not the implementation of the user interface adheres to the localization requirements of the user interface;
obtaining from the response a suggested repair when non-compliance of the localization requirements is determined; and
upon the first large language model indicating that the implementation of the user interface fails to adhere to the localization requirements, outputting the suggested repair.

9. The computer-implemented method of claim 8, wherein the first large language model is trained on natural language data.

10. The computer-implemented method of claim 8, wherein the first large language model is trained on natural language data and visual data.

11. The computer-implemented method of claim 8, wherein obtaining a natural language description of the test case further comprises:
generating a second prompt to a second large language model comprising a snapshot of the test case; and
receiving the natural language description of the test case from the second large language model in response to the prompt.

12. The computer-implemented method of claim 11, wherein the second large language model is trained on natural language and visual data.

13. The computer-implemented method of claim 8, wherein representing, in a natural language description, a visual image of an implementation of the user interface in natural language further comprises:
creating a snapshot of the implementation of the user interface;
generating a third prompt to a visual large language model, wherein the third prompt comprises the snapshot of the implementation of the user interface; and
receiving the natural language description of the snapshot of the implementation of the user interface.

14. The computer-implemented method of claim 8, wherein the localization requirements specify a natural language, a left-to-right reading convention, local currency, local time format, or a right-to-left reading convention.

15. The computer-implemented method of claim 8, wherein the large language model is a neural transformer model with attention.

16. A hardware storage device having stored thereon computer executable instructions that are structured to be executed by a processor of a computing device to thereby cause the computing device to perform actions that:
employ a first large language model to generate a natural language description of a specification of a design feature of a user interface from a snapshot of the specification of the design feature;
employ the first large language model to generate a natural language description of an implementation of the user interface from a snapshot of the implementation of the user interface;
employ a second large language model to determine whether the implementation of the user interface adheres to the specification of the design feature, wherein the second large language model is given the natural language description of the implementation of the user interface and the natural language description of the design feature; and
upon the second large language model determining that the implementation of the user interface fails to comply with the specification of the design feature, output a repair that remedies the failure.

17. The hardware device of claim 16, wherein the first large language model is trained on visual images and natural language data.

18. The hardware device of claim 16, wherein the second large language model is trained on natural language data.

19. The hardware device of claim 16, wherein the large language model is a neural transformer model with attention.

20. The hardware device of claim 16, wherein the design feature pertains to a page layout, text font size, color/contrast, font weight, font decoration, font capitalization, background color, border, shadows, border-radius, spacing in and around text, bounding region size, animation or motion effects, layout position, visual grouping, length of statements, wordiness of statement, left-to-right alignment of text, tone of images, natural language, or text and shapes used in the user interface.
